(19) United States
(12) Patent Application Publication
(10) Pub. No.: US 2009/0138794 A1
(43) Pub. Date: May 28, 2009

(54) SYSTEM AND METHOD FOR SECURING WEB APPLICATIONS

(76) Inventors: Joseph Becker, Garland, TX (US); Carlos Silva-Santisteban, Flower Mound, TX (US)

Correspondence Address: DOCKET CLERK, P.O. DRAWER 800889, DALLAS, TX, 75380, US

(21) Appl. No.: 12/272,583

(22) Filed: Nov. 17, 2008

Related U.S. Application Data
(60) Provisional application No. 61/004,388, filed on Nov. 27, 2007.

(51) Int. Cl. G06F 17/00

(52) U.S. Cl. 715/234

(57) ABSTRACT

A method includes receiving a request to render a web page, where the web page is provided by a web application. The method also includes determining how to modify one or more controls associated with the web page based on a user requesting the web page. The method further includes receiving the web page from the web application and rendering the web page with the one or more modified controls. The receiving, determining, receiving, and rendering steps could be performed by a second application in a manner that is transparent to the web application. Also, determining how to modify the one or more controls could include determining how to modify a visibility of a control, a text of a control, a style of a control, and/or a source property of a control.

### CROSS-REFERENCE TO RELATED APPLICATIONS

This application claims priority under 35 U.S.C. § 119(e) to U.S. Provisional Patent Application No. 61/004,388 filed on Nov. 27, 2007, which is hereby incorporated by reference.

### TECHNICAL FIELD

This disclosure relates generally to network security and more specifically to a system and method for securing web applications.

### BACKGROUND

Many businesses and other organizations have a strong need or desire to secure their web applications. For example, the ability to authenticate users for site access, authorize users for page/directory access, and restrict information and functions to users within a web application are common security requirements. One aspect that developers often face in building security for web applications is addressing the low-level security requirements for a web page. This could include restricting particular users and groups from clicking certain buttons, updating certain form fields, or viewing certain information or content. One example could be the need to restrict anyone who is not part of the accounting group from viewing credit card information for a purchase order. Another example could be restricting anyone who is not part of the purchasing group from updating any information on a purchase order.

Developers are often required to spend significant time building the security components required to handle this granular security control. This can often be a very challenging task that typically requires large amounts of code, which can lead to several problems, headaches, and delays during the development lifecycle. Code clutter, bugs, and security holes can easily result with this type of implementation. In addition, the amount of time required for testing and troubleshooting could be significant. In many cases, businesses and other organizations, as well as development groups, cannot afford the costs and time involved in building a solid security layer that can handle the ever growing and changing security needs of the business or other organization.

### SUMMARY

This disclosure provides a system and method for securing web applications.

In a first embodiment, a method includes receiving a request to render a web page, where the web page is provided by a web application. The method also includes determining how to modify one or more controls associated with the web page based on a user requesting the web page. The method further includes receiving the web page from the web application and rendering the web page with the one or more modified controls.

In a second embodiment, an apparatus includes at least one network interface configured to receive a request to render a web page provided by a web application and to provide a rendered web page. The apparatus also includes at least one processor configured to determine how to modify one or more controls associated with the web page based on a user requesting the web page and render the web page with the one or more modified controls.

In a third embodiment, a method includes storing an assembly application in a specified location associated with a web application. The method also includes updating a configuration file associated with the web application to identify a location of modules in the assembly application. The method further includes defining one or more permissions for one or more users and/or one or more groups, where the one or more permissions are associated with a website provided by the web application. In addition, the method includes rendering a web page for a particular user. The web page is rendered with one or more modified controls, and the one or more modified controls are based on at least one of the one or more permissions.

In a fourth embodiment, a method includes receiving a request to identify one or more web controls associated with a web page at a first process. The method also includes initiating a second process external to the first process. The method further includes instantiating the web page to create an instance of the web page and compiling the instance of the web page using the second process. In addition, the method includes identifying the one or more web controls using the compiled instance of the web page.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system for securing web applications according to this disclosure;

FIGS. 2 through 10 illustrate example graphical user interfaces for securing web applications according to this disclosure;

FIG. 11 illustrates an example method for updating user or group permissions according to this disclosure;

FIG. 12 illustrates an example method for building a site map tree according to this disclosure;

FIG. 13 illustrates an example method for building a page map tree according to this disclosure;

FIG. 14 illustrates an example security database for storing data used to secure web applications according to this disclosure; and

FIGS. 15 through 18 illustrate example activity and sequence diagrams for applying security permissions to a web page request according to this disclosure.

### DETAILED DESCRIPTION

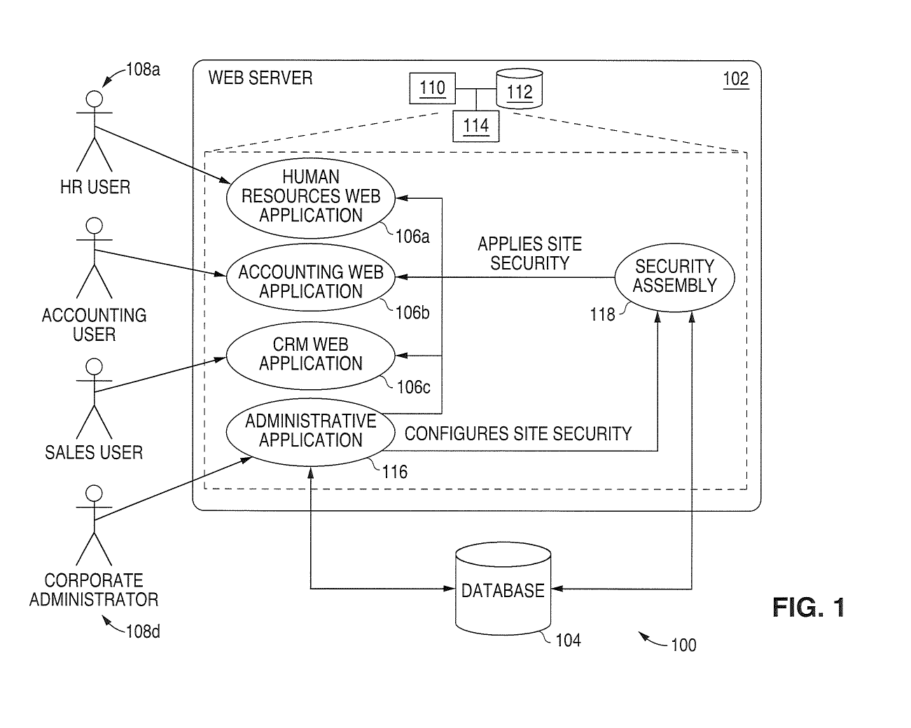

FIGS. 1 through 18, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for securing web applications according to this disclosure. The embodiment of the system 100 shown in FIG. 1 is for illustration only. Other embodiments of the system 100 could be used without departing from the scope of this disclosure.

As shown in FIG. 1, the system 100 includes a web server 102 and a security database 104. The web server 102 generally executes web applications 106a-106c that allow various users 108a-108d to access web pages and invoke functions over a network, such as a local area network, wide area network, the Internet, or other network(s). In this example, the web applications 106a-106c include a human resources web application, an accounting web application, and a customer relationship management (CRM) web application. These web applications 106a-106c are for illustration only. The web server 102 could execute any other or additional web applications according to particular needs. Also, each web application could represent any suitable application, such as a MICROSOFT ASP.NET web application or other web application.

As described in more detail below, the web server 102 also includes a secure application that allows users to easily configure and control security for the web applications 106a-106c. The secure application is described below as being used with MICROSOFT ASP.NET web applications (which currently make up a sizeable portion of the market). However, it should be noted that the secure application is not limited to use with just MICROSOFT ASP.NET technology and can be implemented and/or used with any other suitable technology (including future-developed technology).

The web server 102 represents any suitable device for providing web applications to users. For instance, the web server 102 could represent a computing device having one or more processors 110, one or more memories 112 for storing instructions and data used, generated, or collected by the processor(s) 110, and one or more network interfaces 114 (such as Ethernet interfaces). As a particular example, the web server 102 could represent an Internet Information Services (IIS) web server.

The database 104 stores various information used, generated, or collected by the web server 102. For example, as described in more detail below, the database 104 could store information used by the secure application to secure the web applications 106a-106c executed by the web server 102. The database 104 includes any suitable structure for storing and facilitating retrieval of information. The database 104 could, for example, represent an SQL database.

The various users 108a-108d could access the web server 102 in any suitable manner. For example, the users 108a-108d could use computing or communication devices, such as desktop or laptop computers, personal digital assistants, mobile telephones, or other devices, to access the web server 102 and view web pages provided by the web server 102. The users 108a-108d could use any other or additional type(s) of device(s) to access and interact with the web server 102.

In this example, the secure application used for securing the web applications 106a-106c includes three main components, namely an administrative application 116, the security database 104, and a security assembly 118 that is integrated within a secured website (such as within one or more of the web applications 106a-106c). The administrative application 116 may allow administrators or other personnel to enable the web applications 106a-106c for security, manage users and groups, and update permissions. The security database 104 may retain the site, user, group, and permission data. Each instance of the security assembly 118 may apply the front-end security for one of the web applications 106a-106c. Permissions can include site, page, and folder access, along with page control visibility and disabling.

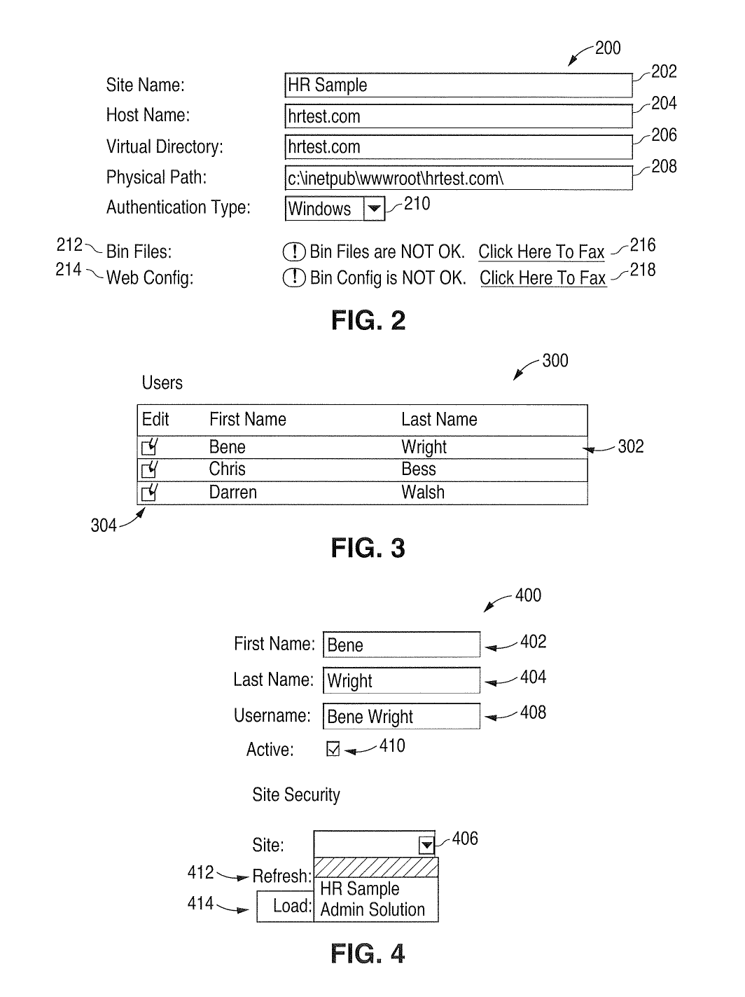

In some embodiments, the secure application implemented using the administrative application 116, the security database 104, and the security assembly 118 represents or implements a layer of security that is transparent to the web applications 106a-106c. In other words, the secure application can seamlessly tie into any existing ASP.NET or other web application 106a-106c to provide site authentication, page/directory authorization, and granular low-level security without the need for any code changes. Also, a simple administrative interface can be provided, which may allow any authorized user to easily set up, modify, or remove security for a web application in a matter of minutes. As an example, low-level securities can be set up with a few mouse clicks. One example of an administrative interface is shown in FIGS. 2 through 10, which are described below. The secure application can further tie into WINDOWS ACTIVE DIRECTORY or other external sources, which can allow businesses and other organizations to leverage their existing ACTIVE DIRECTORY infrastructure to handle WINDOWS securities and their web securities. Among other things, one advantage of the secure application is that it can enable application developers to focus solely on the development of the application being developed (such as a secured website), without needing to give much or any consideration to the security aspects of the site.

Although FIG. 1 illustrates an example system 100 for securing web applications, various changes may be made to FIG. 1. For example, the web server 102 could support any number and type(s) of web applications. Also, any number and type(s) of users could access and interact with the web server 102 in any suitable manner. Further, multiple web servers 102 could be used in the system 100, and one or more databases 104 could be used with one or more web servers 102. Beyond that, the secure application could be used to secure web applications in one or multiple web servers 102, and any number of secure applications could be used. In addition, in some embodiments, the administrative application 116 is web-based and can be installed on the same web server 102 as the web applications 106a-106c that are to be secured. In other embodiments, the administrative application 116 and a web application to be secured can be installed on different devices.

FIGS. 2 through 10 illustrate example graphical user interfaces for securing web applications according to this disclosure. The graphical user interfaces shown in FIGS. 2 through 10 are for illustration only. Other embodiments of the graphical user interfaces could be used without departing from the scope of this disclosure. Also, for ease of explanation, the graphical user interfaces shown in FIGS. 2 through 10 are described as being used by an administrator, although any other suitable personnel could use the graphical user interfaces shown in FIGS. 2 through 10.

Using the administrative application 116, authorized users can enable web applications 106a-106c for application security, manage users and roles, and update permissions. To enable a web application for application security, an administrator can set up the site within the administrative application 116. One example of a graphical user interface 200 for doing this is shown in FIG. 2. As shown here, various user input mechanisms 202-210 (including text boxes and drop-down menus) are provided to receive the appropriate input from the administrator. However, any other suitable input mechanism(s) could be used for each field of information.

Several fields of information may be required to set up security for a web application, such as the site name (text box 202), host name (text box 204), virtual directory (text box 206), local directory or physical path (text box 208), and authentication type to be used by the site (drop-down menu 210). The authentication technique could, for example, include WINDOWS or FORMS authentication. The local directory or physical path can be used to obtain a site map of the web application to be secured (which is described in more detail below). The virtual directory can be used for page compilation (which is also described in more detail below).

In addition, each secured web application 106a-106c can have the security assembly 118 stored in its bin directory or other suitable location, and a configuration update can be made to the web.config file located in the root of the web directory. The administrative application 116 can check for the existence of these adjustments. If one or more do not exist, the administrative application can make the necessary changes by auto-configuring the website. These could be the only modifications required to enable a website for security. To support this functionality, warnings 212-214 can be provided indicating whether the necessary adjustments have been made to the website (whether the security assembly 118 is stored in the appropriate location and whether the web.config file in the root of the web directory is updated). If not, links 216-218 can be provided that initiate these adjustments automatically.

Once a website is configured using the graphical user interface 200, user and group securities can be managed for the website. For example, users and groups can be added to the database 104 via the administrative application 116, or the users and groups can be retained in WINDOWS ACTIVE DIRECTORY or third party databases. Regardless of where the users and groups are stored, permissions can be set for the site, web page, or controls. A user or group can be selected for permission management using a graphical user interface 300 shown in FIG. 3. As shown in FIG. 3, the graphical user interface 300 includes rows 302, where each row identifies an individual user (by first and last names) and includes an edit button 304. The edit button 304 can be selected to present additional information and allow the selected user's permissions to be edited. Note that a similar interface can be used to select and manage group permissions or other permissions.

If the edit button 304 for a particular user is selected in FIG. 3, the administrator is presented with a graphical user interface 400 as shown in FIG. 4. The graphical user interface 400 includes text boxes 402-404 that identify the first name and last name of the selected user. These two text boxes 402-404 can be auto-populated based on the particular user selected in the graphical user interface 300 (and it may or may not be possible to edit these fields). The administrator can select a site to manage using a drop-down menu 406, which allows the administrator to select a particular website. This allows the administrator to set the user's permissions for each site that has been enabled within the secure application.

When a particular site has been selected, the graphical user interface 400 allows the administrator to set a username and to control whether the user is active for that particular site. A text box 408 allows the administrator to set the user's username for the selected site, and a checkbox 410 allows the administrator to indicate whether the selected user is active for that site. A “Refresh” option 412 can be used to refresh the list of possible sites for selection in the drop-down menu 406. Note that while the graphical user interface 400 is shown as being used to control user permissions, the same or similar interface could be used to control group permissions.

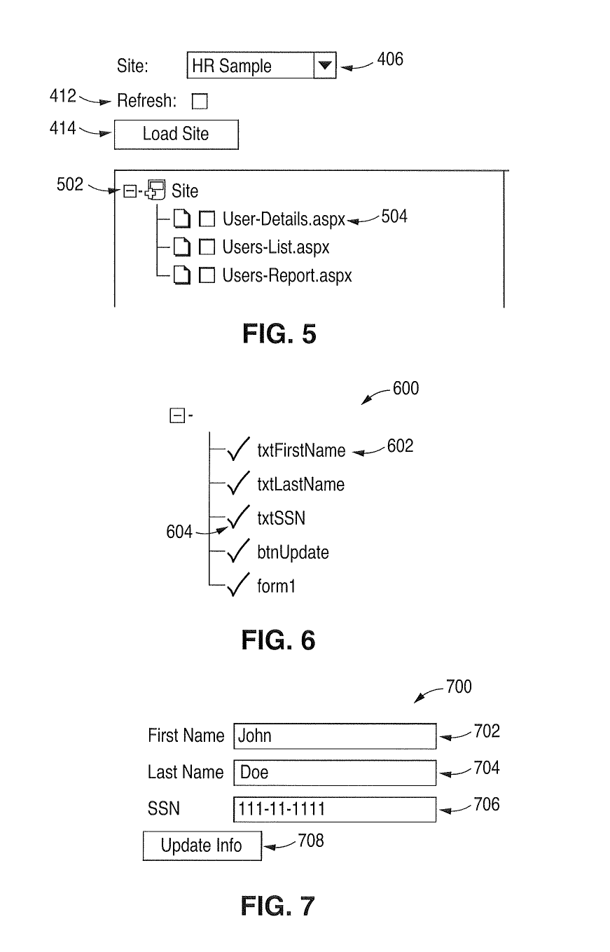

When a site has been selected using the drop-down menu 406, a button 414 in the graphical user interface 400 can be selected, which causes a site map tree to be loaded and shown to the administrator. An example of a site map tree is shown in FIG. 5, which illustrates an additional portion of the graphical user interface 400. Here, a site map tree 502 has been presented to the administrator, where the site map tree 502 identifies one or more pages 504 that can be selected for management. In this example, the administrative application 116 scans the selected website and obtains a list of folders and files that are contained within the web application. These files and folders can be displayed as a tree view to the administrator as shown in FIG. 5. The site map tree 502 allows the administrator to select a particular page 504 to manage.

Once a page 504 is selected in the site map tree 502, page controls can be dynamically loaded and presented to the administrator in a page map tree. One example of a page map tree 600 is shown in FIG. 6. Below is example source code of a selected page (assuming that the User-Details.aspx page was selected).

```
<%@ Page Language=“C#” AutoEventWireup=“true” %>
<form id=“forml” runat=“server”>
<table>
  <tr>
    <td>First Name</td>
    <td><asp:TextBox id=“txtFirstName” runat=“server” text=“John”
    /></td>
  </tr>
  <tr>
    <td>Last Name</td>
    <td><asp:TextBox id=“txtLastName” runat=“server” text=“Doe”
    /></td>
  </tr>
  <tr>
    <td>SSN</td>
    <td><asp:TextBox id=“txtSSN” runat=“server” text=“111-11-1111”
    /></td>
  </tr>
</table>
<asp:Button id=“btnUpdate” runat=“server” text=“Update Info” />
</form>
```

The code here shows the following controls: form1, txtFirstName, txtLastName, txtSSN, and btnupdate. The secure application can automatically read these controls and show them to the administrator, such as in the page map tree 600. In FIG. 6, the page map tree 600 identifies multiple controls 602 and a visibility indicator 604 for each control. The controls 602 represent the controls that can be displayed in a web page, and the visibility indicators 604 identify which controls are actually displayed in the web page according to the secure application. Each visibility indicator 604 could, for example, include a checkmark (for visible controls), a padlock (for disabled controls), or a crossmark (for invisible or hidden controls).

FIG. 7 illustrates one example of a browser view 700 of a web page prior to a permission update. Here, the browser view 700 includes text boxes 702-704 containing a person's first and last names. These boxes may be shaded to indicate that these fields cannot be changed. Another text box 706 can be used to provide a social security number (SSN), and a button 708 can be used to update the person's information.

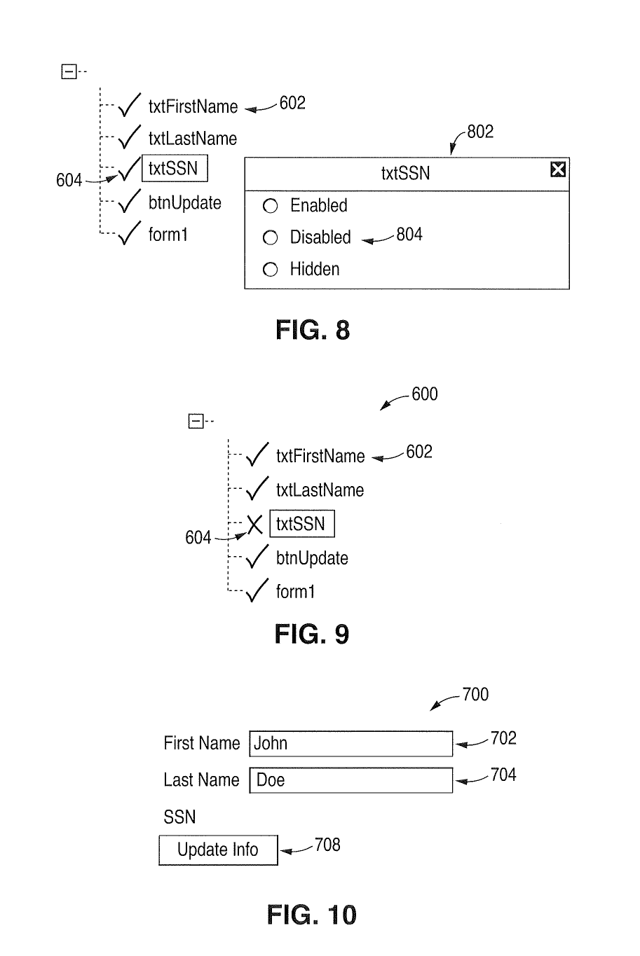

In the page map tree 600, the administrator can select a control 602 to modify permissions associated with the displayed fields in FIG. 7, such as by clicking on a particular control 602 to view a permission window 802 as shown in FIG. 8. The permission window 802 identifies the permission options that can be selected by the administrator for the particular control 602. In this example, the administrator can set the social security number textbox 706 so that it is enabled, disabled, or hidden from the user whose permissions are being modified. Once the permission is selected in the permission window 802, the window 802 may disappear, and the page map tree 600 can be updated to reflect the permission change. For example, if the SSN control is set to “Hidden,” the page map tree 600 could be updated as shown in FIG. 9. In FIG. 9, the visibility indicator 604 of the SSN control 602 has been updated to show that this control is not presented to the user whose permissions are being modified. Once the change is made, the database 104 can be updated to retain the user's updated control permissions. In the example above, the browser view 700 of the web page can be changed as shown in FIG. 10. Here, the text box 706 has been removed (hidden) so that the selected user cannot update the person's social security number. In other words, the txtSSN control 706 is now hidden from the user.

In this way, security can be established for individual users on various websites. In a similar way, security can be established for groups of users on the various websites. Moreover, this can be done without changes to any source code within the web applications being secured. Instead, as shown here, the secure application acts to “intercept” the web page, determines how to modify the controls of the web page, and allows the web page to be displayed in the modified manner. No changes are necessary to the underlying web application that generates the web page.

The graphical user interfaces shown in FIGS. 2 through 10 could be implemented in any suitable manner. For example, any suitable programming language can be used to create the graphical user interfaces, such as object-oriented languages, Java-based languages, or Javascript-based languages such as Ajax.

Although FIGS. 2 through 10 illustrate example graphical user interfaces for securing web applications, various changes may be made to FIGS. 2 through 10. For example, while certain input mechanisms (such as text boxes, drop-down menus, checkboxes, and buttons) have been shown, any other suitable input mechanisms could be used to collect data from or otherwise interact with an administrator or other user. Also, the content, layout, and arrangement in each graphical user interface are for illustration only.

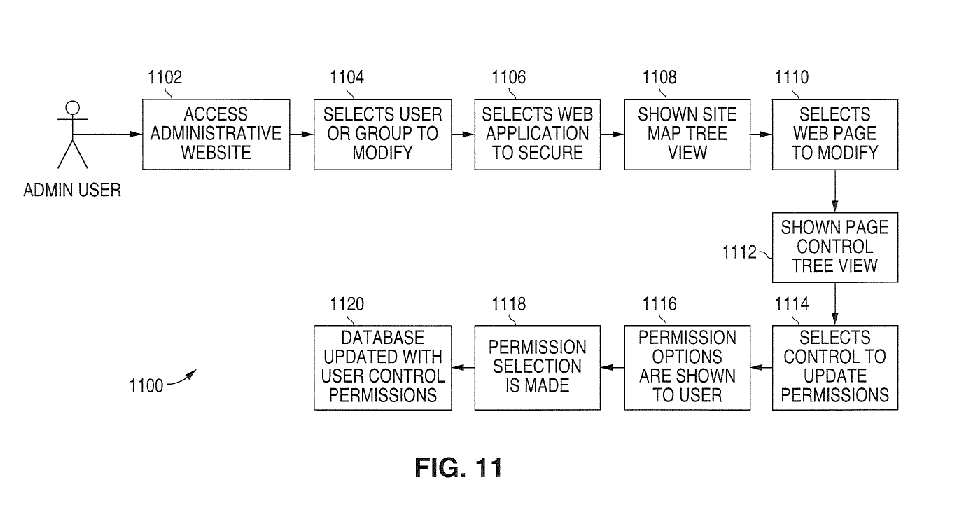

FIG. 11 illustrates an example method 1100 for updating user or group permissions according to this disclosure. The embodiment of the method 1100 shown in FIG. 11 is for illustration only. Other embodiments of the method 1100 could be used without departing from the scope of this disclosure. Also, for ease of explanation, the method 1100 shown in FIG. 11 is described as being used by an administrator, although any other suitable personnel could use the method 1100 shown in FIG. 11.

In this example, the method 1100 can be used to update user or group permissions for a web application. The administrator accesses an administrative application at step 1102. This could include, for example, the administrator accessing the administrative application 116 via a web browser on a desktop computer, laptop computer, personal digital assistant, or mobile telephone.

The administrator selects a user or group for permission management at step 1104. This could include, for example, the administrator selecting a user from the graphical user interface 300. A similar type of graphical user interface could be used to select a group for permission management.

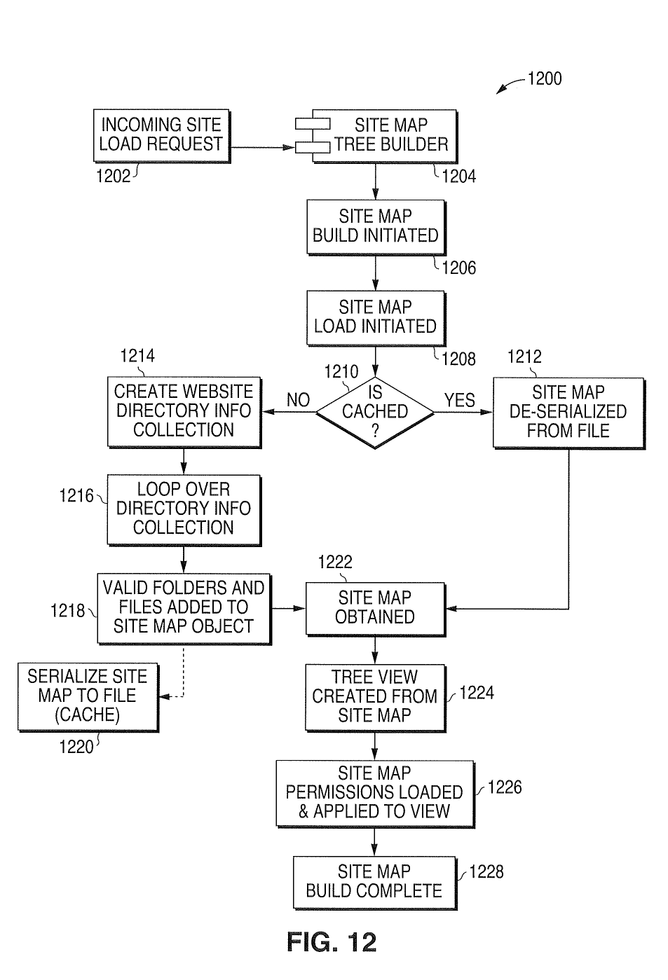

The administrator selects a web application to be secured at step 1106. This could include, for example, the administrator using the graphical user interface 400 to select a site to manage (via the drop-down menu 406). A site map tree view is presented to the administrator at step 1108. This could include, for example, the administrator viewing a site tree map 502 associated with the selected web application. An example method for generating a site tree map is shown in FIG. 12, which is described below.

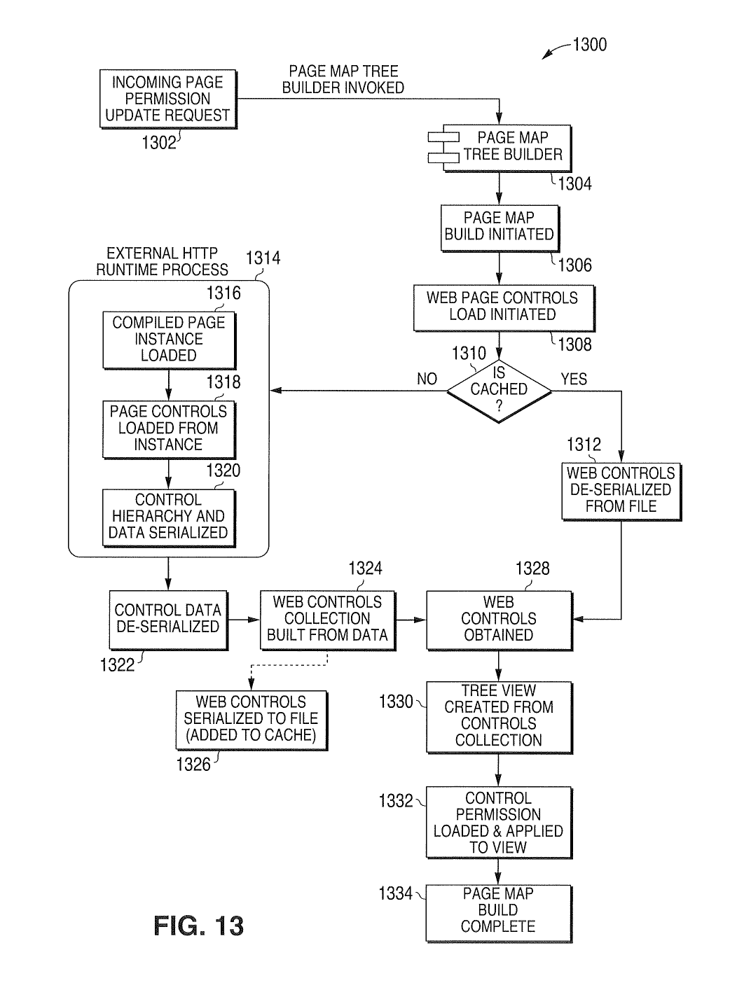

The administrator selects a web page to modify at step 1110. This could include, for example, the administrator selecting one of the web pages listed in the site tree map 502. A page control tree view for the selected website is presented at step 1112. This could include, for example, the administrator viewing a page map tree 600 associated with the selected website. An example method for generating a page map tree is shown in FIG. 13, which is described below.

The administrator selects a control for which the permissions are to be updated at step 1114, and permission options are presented to the administrator at step 1116. This could include, for example, the administrator selecting a particular control 602 in the page map tree 600 in order to view the permission window 802 for that control. A permission selection is made at step 1118, and a database is updated with the permission selection at step 1120. This could include, for example, receiving the administrator's selection via the permission window 802 and updating the database 104 to reflect the permission for the selected user or group, the selected web application, and the selected web page.

Although FIG. 11 illustrates an example method for updating user or group permissions, various changes may be made to FIG. 11. For example, permissions could be set or controlled using any suitable graphical user interface or other mechanism. Also, various steps in FIG. 11 could overlap, occur in parallel, occur multiple times, or occur in a different order.

FIG. 12 illustrates an example method 1200 for building a site map tree according to this disclosure. The embodiment of the method 1200 shown in FIG. 12 is for illustration only. Other embodiments of the method 1200 could be used without departing from the scope of this disclosure. Also, for ease of explanation, the method 1200 shown in FIG. 12 is described as being used by an administrator, although any other suitable personnel could use the method 1200 shown in FIG. 12.

An incoming site load request is received at step 1202. The request could indicate a request to load a particular website. For example, the administrator can trigger a site load request by selecting a site within the graphical user interface 400 or other user interface.

A site map tree builder object is instantiated at step 1204. The site map tree builder object could be created according to a software application executed by the processor 110 in the web server 102. A site map build process is initiated by the site map tree builder object at step 1206, where the process is performed to build the site map tree.

A site map load process is initiated by the site map tree builder object at step 1208, and a determination is made whether a site map for the requested site exists in a cache at step 1210. This may include, for example, the site map tree builder object determining whether the site map is cached in a file on a local disk or other storage. If it is, the site map is de-serialized from a file in the cache at step 1212, and the site map structure is obtained by the site map tree builder object at step 1222. This can be done to prevent an unnecessary directory scan of the physical site files, thus improving performance for the application.

Otherwise, if the site map is not cached, a website directory information collection structure is created at step 1214. This structure may include an in-memory representation of the physical file structure of a website. This structure may contain the information about all of the files and folders within the website directory. The directory information collection structure is examined at step 1216, and valid files and folders can be added to a site map structure object at step 1218. The site map structure object then contains a representation the selected site directory structure. In some embodiments, only .aspx files are included in the site map structure object, since securities cannot be managed for other file types. The site map structure object is cached at step 1220, such as by serializing the site map structure object and saving it as a physical file to be read for future use. The site map structure is obtained by the site map tree builder object at step 1222.

Once the site map structure is obtained, a site map tree view is created based on the site map structure at step 1224. The tree view may or may not leverage third-party control for the display of the expandable/collapsible view of the site map directory structure. After the tree view is created, the user/group site permissions can be loaded from the database and applied to the view at step 1226. For example, if page or folder access is restricted for the user, this can be denoted with a checkmark next to the file or folder. At this point, the site map build process is complete at step 1228, and the site map can be presented to the user.

Although FIG. 12 illustrates an example method 1200 for building a site map tree, various changes may be made to FIG. 12. For example, any other suitable technique could be used to identify a site map tree for a specific web application. Also, various steps in FIG. 12 could overlap, occur in parallel, occur multiple times, or occur in a different order.

FIG. 13 illustrates an example method 1300 for building a page map tree according to this disclosure. The embodiment of the method 1300 shown in FIG. 13 is for illustration only. Other embodiments of the method 1300 could be used without departing from the scope of this disclosure. Also, for ease of explanation, the method 1300 shown in FIG. 13 is described as being used by an administrator, although any other suitable personnel could use the method 1300 shown in FIG. 13.

An incoming page permission update request is received at step 1302. As noted above, from the site map tree view, the administrator can select a page to manage. An incoming page permission update request can be triggered by the administrator selecting a page from the site map tree view (among other ways). This can instantiate a page map tree builder object at step 1304 and initiate a page map build process at step 1306.

A web page controls load process is initiated by the page map tree builder object at step 1308, and a determination is made whether the web controls are cached at step 1310. This could include, for example, the builder object checking to see if the web controls are cached to a file on a local disk or other storage. If the web controls are cached, the web controls are obtained from the cache at step 1312. This could include, for example, a web controls collection object being de-serialized from the cache and being instantiated in-memory, where the collection object is retained by the builder object. The web controls in the selected web page are obtained at step 1328, where the collection object identifies the web controls.

If the web controls are not cached, an external HTTP runtime process is created to host the page load and instantiation required to obtain the control list at step 1314. In some embodiments, since the .NET framework prevents external page loads within the same hosted process, an external process can be invoked. Within the HTTP runtime process, the page is instantiated and compiled at step 1316, which allows the secure application to get a handle on the control information and hierarchy contained within the page. The page controls are loaded from the instance at step 1318. Also, the page control hierarchy and field information are collected at step 1320, such as by being serialized into a collection object that retains this information. The hierarchy represents the nesting of the controls found within the page, and the field information contains the names and types of controls found on the page. The serialized collection object can be returned to the builder object and then de-serialized at step 1322. The builder object may use this information to create the web controls collection object, which is used during the tree view build process, at step 1324. The web controls collection object can be cached at step 1326, such as by serializing the object and saving it to disk, and the collection object is retained by the builder object. The web controls in the selected web page are obtained at step 1328, where the collection object identifies the web controls.

The page map build process then proceeds based on the data found within the web controls collection object. A tree view is created using the web controls identified by the collection object at step 1330. The tree view may leverage third-party control for displaying the control hierarchy. Also, the user/group control permissions can be pulled from the database and applied to the tree view at step 1332. For example, control visibility can be denoted with a checkmark, control disabling can be denoted with a padlock, and control invisibility can be denoted with a crossmark. At this point, the page map building process is complete at step 1334.

Although FIG. 13 illustrates an example method 1300 for building a page map tree, various changes may be made to FIG. 13. For example, any other suitable technique could be used to identify a page map tree for a specific web page. Also, various steps in FIG. 13 could overlap, occur in parallel, occur multiple times, or occur in a different order.

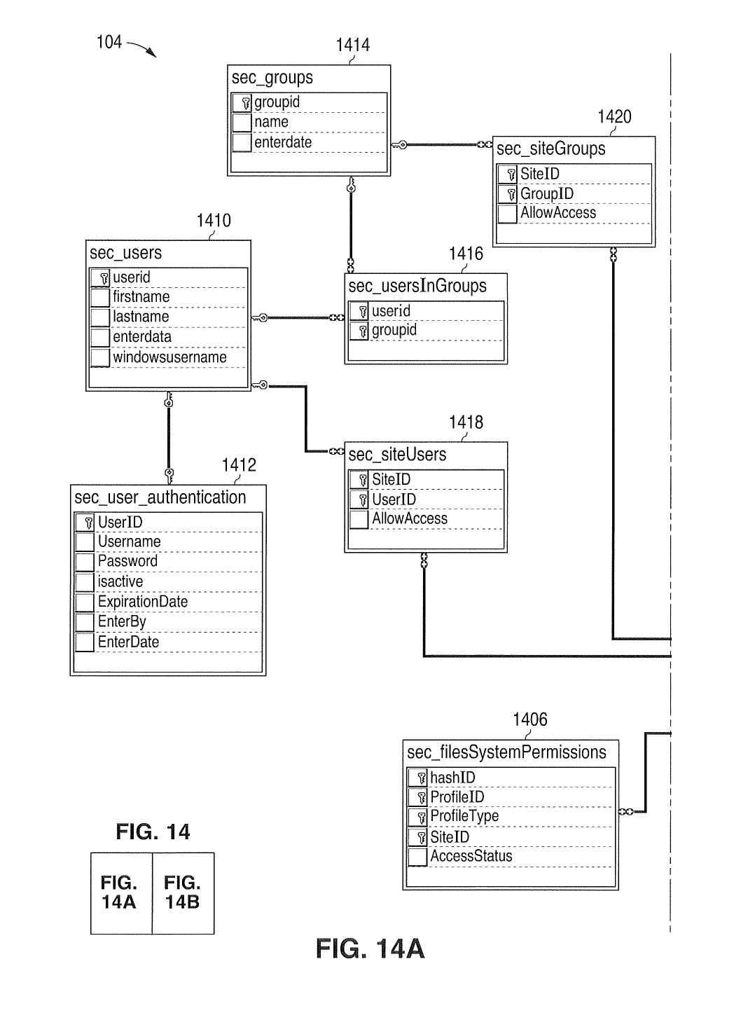

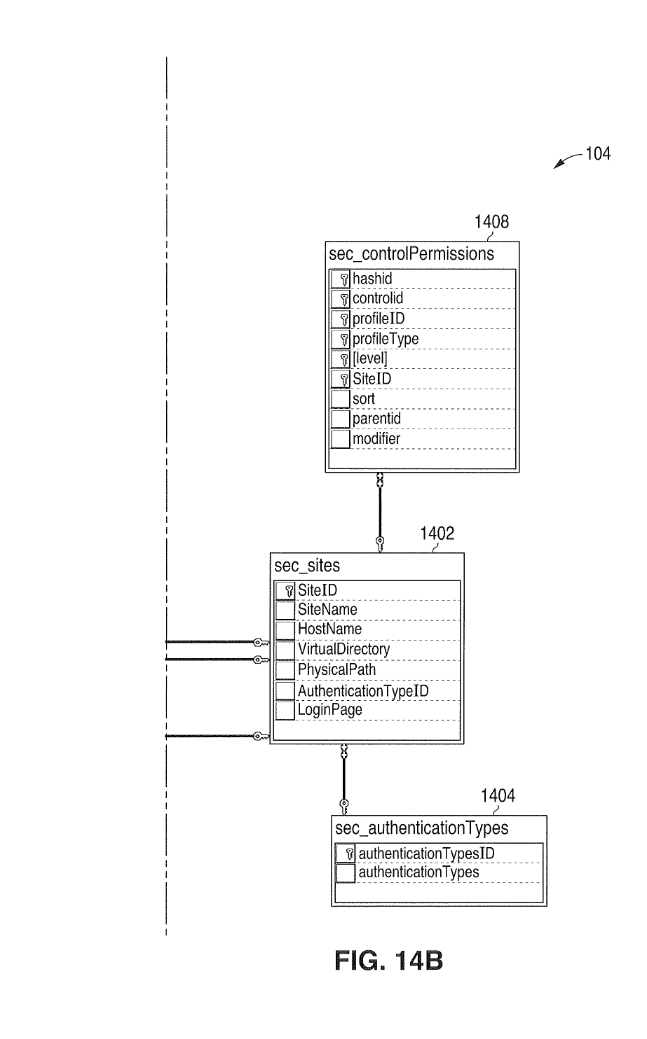

FIG. 14 illustrates an example security database 104 for storing data used to secure web applications according to this disclosure. The embodiment of the security database 104 shown in FIG. 14 is for illustration only. Other embodiments of the security database 104 could be used without departing from the scope of this disclosure.

The following tables are used in this particular implementation of the security database 104. A sec_sites table 1402 holds records for each security-enabled site within the secure application. Columns can include site identifiers, site names, host names (such as www.xyz.com), virtual directories, physical paths (such as c:\inetpub\wwwroot\xyz), and authentication type identifiers (relate to authentication types table such as [FORMS,WINDOWS]).

A sec_authenticationTypes table 1404 represents an enumeration table for the authentication types supported by the secure application. FORMS and WINDOWS authentication can be supported, and other authentication types could also be supported. Columns can include authentication type identifiers and authentication types (names).

A sec_fileSystemPermissions table 1406 retains user and group permissions for folders and pages. Columns can include hash identifiers, profile identifiers (user or group identifiers), profile types (users or groups), site identifiers (related sites), and access statuses (granted or denied). These hash identifiers may represent numerical representations of the page or table physical filename hash codes, which are used to relate the rows to physical files.

A sec_controlpermissions table 1408 maintains user and group permissions for page controls. Columns can include hash identifiers, profile identifiers (user or group identifiers), profile types (users or groups), levels (the hierarchical level of the controls), site identifiers (related sites), sorts (string entries used to sort the control lists for proper display), parent identifiers (string representations of the parent identifiers' hierarchy), and modifiers (enable, disable, hide). These hash identifiers may represent numerical representations of the controls physical filename hash codes, which are used to relate the rows to the page controls.

A sec_users table 1410 holds users that have been added to the secure application for security management. Columns can include user identifiers, first names, and last names.

A sec_user_Authentication table 1412 retains user authentication information. Columns can include user identifiers (relates to sec_users table), usernames, passwords, is Active flags (yes/no), and expiration dates (dates that passwords expire).

A sec_groups table 1414 holds groups that have been added to the secure application for security management. Columns can include group identifiers and group names.

A sec_usersInGroups table 1416 represents a joining table that relates users to groups. Columns can include user identifiers and group identifiers.

A sec_sitesUsers table 1418 represents a joining table that relates users to sites. Columns can include site identifiers, user identifiers, and allow access flags (yes/no).

A sec_sitesGroups table 1420 represents a joining table that relates groups to sites. Columns can include site identifiers, group identifiers, and allow access flags (yes/no).

Although FIG. 14 illustrates an example security database 104 for securing web applications, various changes may be made to FIG. 14. For example, the tables 1402-1420 shown in FIG. 14 are for illustration only. Various tables could be combined or further subdivided and other or additional tables could be used according to particular needs.

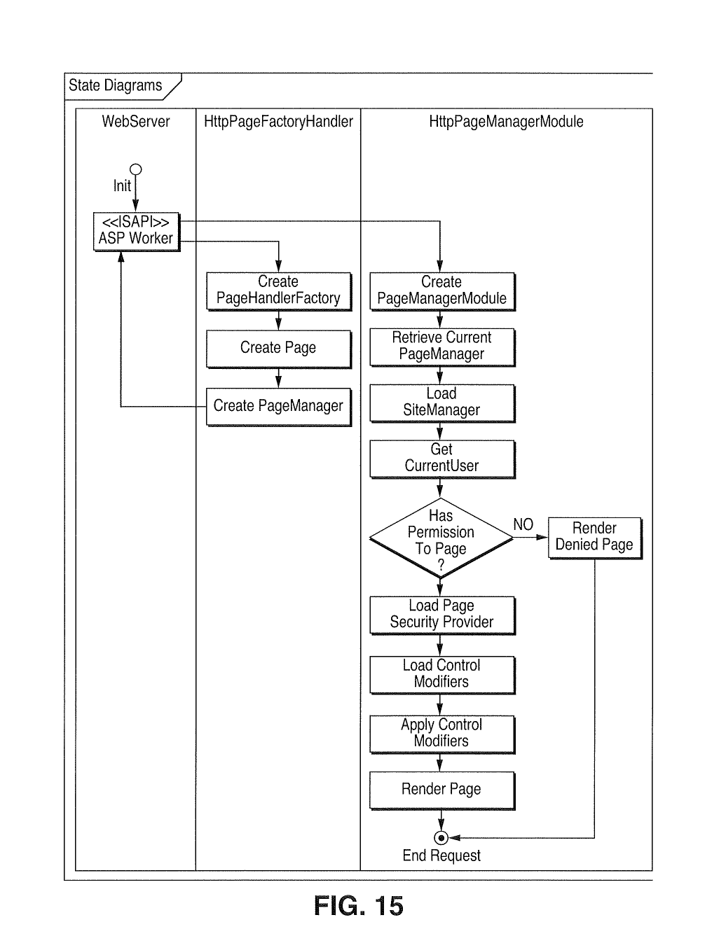

FIGS. 15 through 18 illustrate example activity and sequence diagrams for applying security permissions to a web page request according to this disclosure. The embodiment of the activity and sequence diagrams shown in FIGS. 15 through 18 is for illustration only. Other embodiments of the activity and sequence diagrams could be used without departing from the scope of this disclosure.

As noted above, one of the components of the secure application in FIG. 1 is the security assembly 118. In some embodiments, the security assembly 118 is a dynamic link library (DLL) file that is installed in a secured website's bin directory. The security assembly 118 can apply securities “on-the-fly” during a user's page request. The security assembly 118 may also work independently of the source code of the web application, so the integration can be seamless and require no programming. As noted above, after a website has been enabled (such as via the graphical user interface of FIG. 2) and permissions created for the site's users and groups (such as via the graphical user interfaces of FIGS. 3-10) within the administrative application 116, the website may need two modifications in order for the securities to be applied during user page requests: the security assembly 118 is placed in the bin directory, and the following tags are added to the system.web section of the web.config file:

```
<httpHandlers>
  <add verb=“*” path=“*.aspx”
type=“SecureDotNet.PageFactory.PageHandlerFactory,SedureDotNet”/>
</httpHandlers>
<httpModules>
  <add type=“SecureDotNet.PageManagerModule,SecureDotNet”
name=“SetPermissions”/>
</httpModules>
```

After these are in place, subsequent user page requests for the site may be secured automatically, and site, folder, and page access can be secured along with page control visibility and enabling.

Within the security assembly 118 are several objects that manage the applying of page securities. These objects can be contained within the security assembly 118 and can be attached to the secured website via the web.config modifications. These objects may include:

PageManager—This object may be responsible for applying security rules to a page request.

PageManagerModule—This object may be responsible for coordinating the user authentication and PageManager security invocations.

PageFactoryHandler—This is a specific implementation of the existing .NET object. This object may be responsible for creating a page object instance of the request and attaching the PageManager object to the request.

SiteManager—This object may obtain the user/group permission rules for the site that is being accessed.

The following describes an example process for applying security permissions during a single page request. This example is illustrated in FIG. 15. An ASP.NET worker receives a page load request, which may occur when a user accesses a page within the secured website. The PageFactoryHandler object is then instantiated and receives the incoming request. The PageFactoryHandler object instantiates the request as a System.Page object. The PageManager object instance is created for the request, and the PageManager object is attached to the current request.

The PageFactoryHandler object returns the request instance back to the ASP.NET worker, which loads the PageManagerModule object and passes the request instance to this module. The PageManagerModule retrieves the PageManager object from the incoming request, and the SiteManager object is created based on the current site that is being accessed. The user's identity is determined in relation to the current site, and the request is authenticated (authentication can be based on whether the current user can access the requested page).

If the user does not have access to the requested page, access is denied, and the request is terminated. If permission is granted, the page security provider for the current site is loaded. Page modifiers for the current user and current page are loaded, where the page modifiers contain the security rules for the page requested. These rules tell the system the permission level of the control for the current user. The modifiers can be managed within the administrative portion of the secure application (the administrative application 116). Page modifiers are applied to the current page, and these modifiers adjust the current page render to hide or disable the necessary controls. The secured page is then rendered and returned to the requesting browser. In this way, the secure application can intercept the request for a web page, determine how the web page should be modified to enforce the desired security, and render the page in line with those modifications.

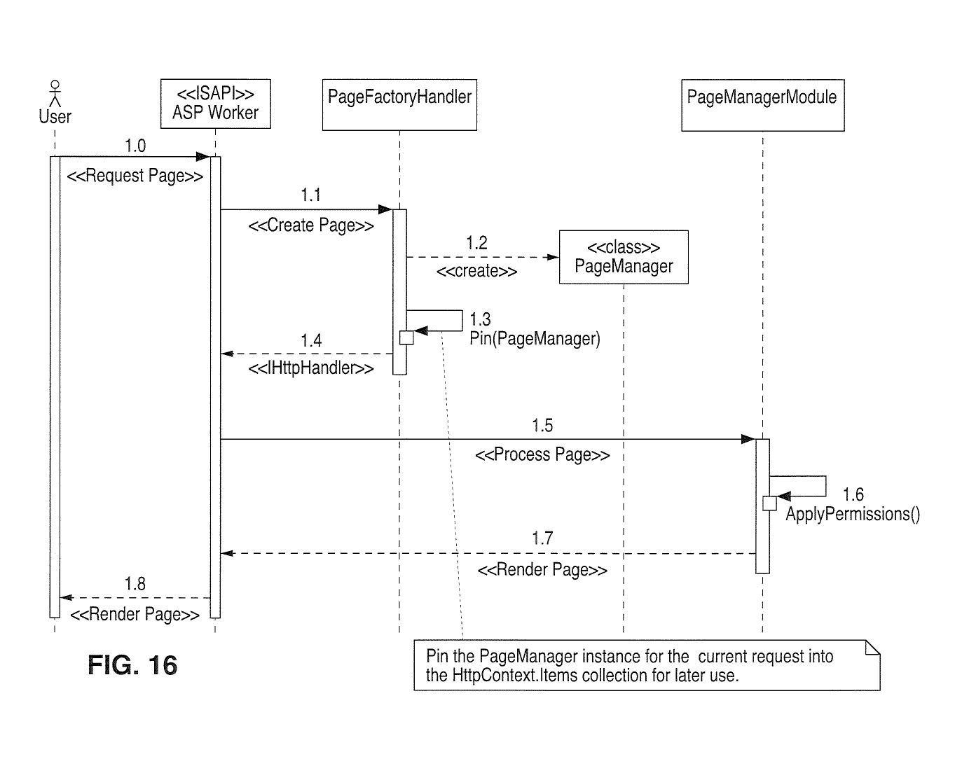

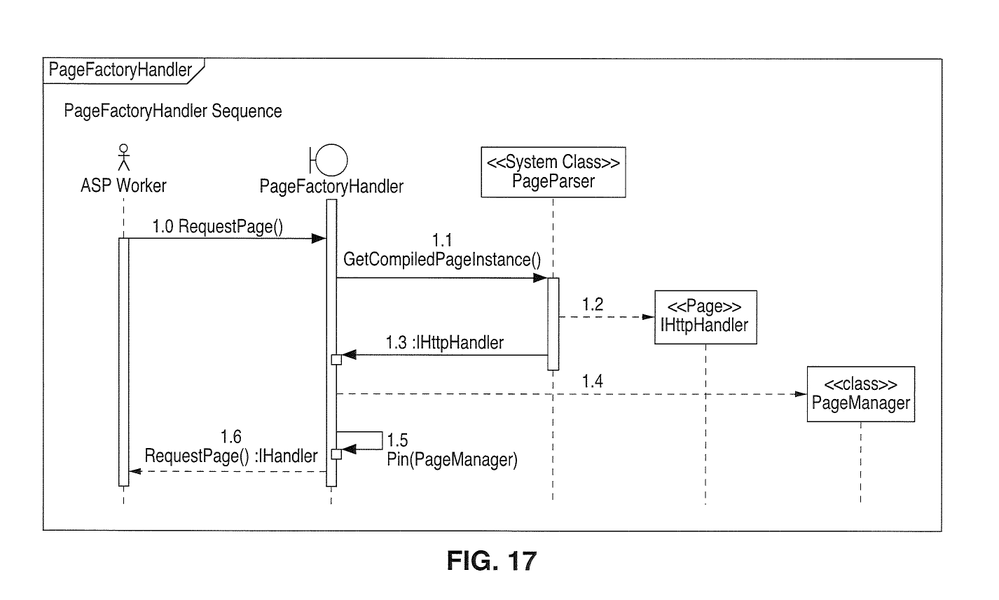

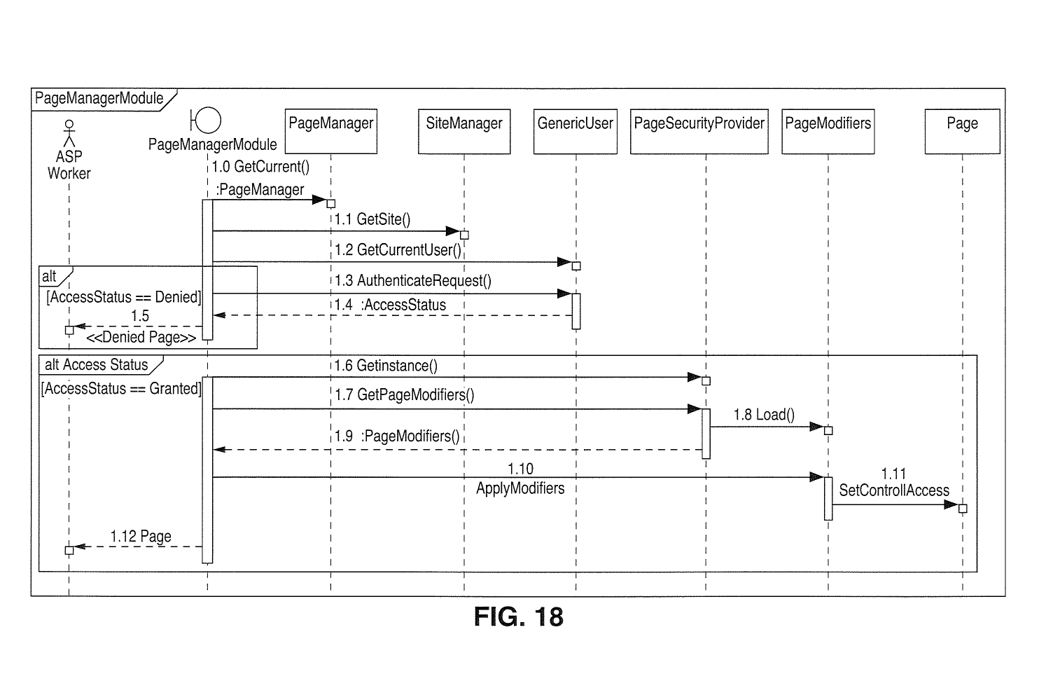

FIG. 16 illustrates the same general sequence of events. FIG. 17 illustrates the operations of the PageFactoryHandler object, where the PageFactoryHandler object creates a page object instance of the request and attaches the PageManager object to the request. FIG. 18 illustrates operations of the PageManagerModule object, which coordinates the user authentication and PageManager security invocations. The modifiers referred to in FIG. 18 denote any changes made to the controls of a web page, where the changes are made to implement the security provided by the secure application.

Although FIGS. 15 through 18 illustrate example activity and sequence diagrams for applying security permissions to a web page request, various changes may be made to FIGS. 15 through 18. For example, the components involved in applying the security permissions to the web page request are for illustration only.

Also note that while FIGS. 1 through 18 have described various aspects of the secure application and its operation, the ability to manage web applications and websites can be extended in any suitable manner. For example, the secure application can be designed to secure and manage multiple sites. Each site can leverage different authentication providers, such as WINDOWS ACTIVE DIRECTORY, an existing user database, or the applications default provider. In some embodiments, the authentication provider may serve as the user and group data store and implement user authentication. The user and group permissions may still be maintained within the secure application's database 104. This technique allows for the separation of the user database from the permissions database. In doing so, application implementers can leverage their existing user databases without having to migrate and synchronize this information with the security database. At the same time, the default provider is available to implementers that do not have an existing user database. The authentication provider that a particular site uses can be easily adjusted, for example, by modifying the secure application's configuration XML file. The configuration XML file may indicate to the secure application which authentication provider to use for a specific website. If a website is not configured to use a specific provider in the XML file, the default provider is used. Developers can create their own custom authentication providers by implementing SiteManager and GenericUser objects located in the security assembly 118. This provides the ability for the application to integrate with any existing or future user data store that can be accessed programmatically.

The steps below describe one example process for invoking a security provider during a user page request. The browser requests a page, and the PageManagerModule requests a SiteManager. The SiteManager is the provider object that implements custom or built-in authentication. The secure application checks for an existing SiteManager object in memory. If no SiteManager object exists, the SiteManager object is loaded from the applications configuration XML file (where the XML file is searched for the SiteManager configured for the site being accessed). If no SiteManager is found, the default site manager configured in the configuration XML file is loaded. If a SiteManager is found, the assembly and class instance of the SiteManager is loaded into memory, the SiteManager is returned to the PageManagerModule, and page authentication is performed using the implementation of the loaded SiteManager.

Due to the flexible nature and architecture of the secure application, many enhancements are possible. For example, control properties can be managed. Since the secure application can get a handle on a web control prior to its rendering, any property of the control can be manipulated prior to a page render. These properties can include text, style, and source properties of the control (which may be collectively referred to as “states” of the web page controls).

Data display adjustments can also be made. Specific information that is rendered on the page either in stand-alone or repeatable controls can be suppressed based on permissions. This can allow for seamless data filtering.

In addition, IIS network discovery and integration can be implemented. In some embodiments, the secure application is installed on the IIS server for the sites to be secured. In other embodiments, the secure application can scan a network for existing IIS servers, and the secure application can integrate into sites hosted on any IIS servers identified during the scan.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It should also be noted that the secure application could be executed on any suitable device. For example, the secure application could be executed on a server or other computing device having one or more processors, one or more memories for storing instructions and data used, generated, or collected by the processor(s), and one or more network interfaces (such as Ethernet interfaces). In may further be noted that the functionality described above as being performed or provided by the secure application could also be implemented using any hardware, software, firmware, or combination thereof.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving a request to render a web page, the web page provided by a web application;
determining how to modify one or more controls associated with the web page based on a user requesting the web page;
receiving the web page from the web application; and
rendering the web page with the one or more modified controls.

2. The method of claim 1, wherein the receiving, determining, receiving, and rendering steps are performed by a second application in a manner that is transparent to the web application.

3. The method of claim 1, wherein receiving the request to render the web page comprises intercepting the request before the request is received by the web application; and
further comprising transmitting the request to the web application.

4. The method of claim 1, wherein determining how to modify the one or more controls comprises determining how to modify at least one of: a visibility of a control, a text of a control, a style of a control, and a source property of a control.

5. The method of claim 1, wherein determining how to modify the one or more controls comprises:
instantiating a handler object that receives the request, instantiates a page manager object, and attaches the page manager object to the request;
loading a manager module object and passing the request with the attached page manager object to the manager module object;
authenticating the user at the manager module object; and
when the user is authenticated, applying one or more page modifiers to the web page prior to rendering the web page, the one or more page modifiers comprising one or more security rules for the web page.

6. An apparatus comprising:
at least one network interface configured to receive a request to render a web page provided by a web application and to provide a rendered web page; and
at least one processor configured to:
determine how to modify one or more controls associated with the web page based on a user requesting the web page; and
render the web page with the one or more modified controls.

7. The apparatus of claim 6, wherein the at least one processor is further configured to:
execute the web application to provide the web page; and
execute a second application, the second application configured to determine how to modify the one or more controls and to render the web page in a manner that is transparent to the web application.

8. The apparatus of claim 7, wherein the second application is configured to receive the request and to transmit the request to the web application.

9. The apparatus of claim 7, wherein the second application comprises:
a handler object configured to receive the request, instantiate a page manager object, and attach the page manager object to the request; and
a manager module object configured to:
receive the request with the attached page manager object;
authenticate the user; and
when the user is authenticated, apply one or more page modifiers to the web page prior to the rendering of the web page, the one or more page modifiers comprising one or more security rules for the web page.

10. The apparatus of claim 6, wherein the at least one processor is configured to determine how to modify the one or more controls by determining how to modify at least one of: a visibility of a control, a text of a control, a style of a control, and a source property of a control.

11. A method comprising:
storing an assembly application in a specified location associated with a web application;
updating a configuration file associated with the web application to identify a location of modules in the assembly application;
defining one or more permissions for at least one of: one or more users and one or more groups, the one or more permissions associated with a website provided by the web application; and
rendering a web page for a particular user, the web page rendered with one or more modified controls, the one or more modified controls based on at least one of the one or more permissions.

12. The method of claim 11, wherein storing the assembly application and updating the configuration file comprises:
determining whether the assembly application has been stored in the specified location and whether the configuration file has been updated;
if the assembly application has not been stored in the specified location, providing a first link that causes the assembly application to be automatically stored in the specified location when selected; and
if the configuration file has not been updated, providing a second link that causes the configuration file to be automatically updated when selected.

13. The method of claim 11, wherein defining the one or more permissions comprises displaying one or more graphical user interfaces configured to:
receive input identifying one of: a user and a group of users; and
receive input defining the one or more permissions for the user or group of users.

14. The method of claim 13, wherein the one or more graphical user interfaces are further configured to:
receive input identifying the web application;
display a site map tree associated with the web application, the site map tree containing multiple websites associated with the web application; and
receive a selection of one of the websites.

15. The method of claim 14, wherein the one or more graphical user interfaces are further configured to:
display a page map tree associated with the selected website, the page map tree containing multiple controls associated with the selected website;
receive a selection of one of the controls;
display a permission window containing permission options associated with the selected control; and
receive a selection of one of the permission options, the selected permission option comprising one of the one or more defined permissions.

16. The method of claim 11, wherein rendering the web page comprises determining how to modify, based on at least one of the one or more permissions, at least one of: a visibility of a control, a text of a control, a style of a control, and a source property of a control.

17. A method comprising:
receiving a request to identify one or more web controls associated with a web page at a first process;
initiating a second process external to the first process;
instantiating the web page to create an instance of the web page and compiling the instance of the web page using the second process; and
identifying the one or more web controls using the compiled instance of the web page.

18. The method of claim 17, further comprising:
displaying a page map tree associated with the web page to a user, the page map tree identifying the one or more web controls.

19. The method of claim 17, wherein:
the first and second applications are executed within a .NET framework; and
the web page is provided by a ASP.NET web application.

20. The method of claim 17, further comprising:
building a collection object that includes information defining the one or more web controls; and
serializing the collection object to a file in a cache.
